(19) United States
(12) Patent Application Publication
(10) Pub. No.: US 2021/0182951 A1
(43) Pub. Date: Jun. 17, 2021

(54) Dynamic Contiguous Fractional Space Allocation Engine

(71) Applicant: Tomas Louda, Austin, TX (US)

(72) Inventor: Tomas Louda, Austin, TX (US)

(21) Appl. No.: 17/117,262

(22) Filed: Dec. 10, 2020

Related U.S. Application Data
(60) Provisional application No. 62/947,397, filed on Dec. 12, 2019.

(51) Int. Cl. G06Q 30/06; G06F 16/2457; G06F 16/23

(52) U.S. Cl. CPC G06Q 30/0645; G06F 16/2379; G06F 16/24575

(57) ABSTRACT

Apparatus and associated methods relate to a dynamic contiguous fractional space allocation engine. In an illustrative example, the allocation engine may be configured to predetermine a plurality of unique units of fractional space for an operator defined physical storage space. The allocation engine may be configured to receive a space request for items having predetermined space requirements. Unique IDs may be generated for the items. The allocation engine may be configured to determine unused unique units of fractional contiguous space sufficient to receive the items. The items' unique IDs may be associated with the unique units of fractional contiguous space. The allocation engine may advantageously dynamically allocate contiguous storage space by fractionalizing a larger storage space, dynamically assign storage customers to storage operators, and/or automatically coordinate interactions between customers, operators, and/or transporters.

### CROSS-REFERENCE TO RELATED APPLICATIONS

This application claims the benefit of U.S. Provisional Application Ser. No. 62/947,397, titled “DYNAMIC CONTIGUOUS FRACTIONAL SPACE ALLOCATION ENGINE,” filed by Tomas Louda, et al., on Dec. 12, 2019.

This application incorporates the entire contents of the foregoing application(s) herein by reference.

### TECHNICAL FIELD

Various embodiments generally relate to space allocation engines.

### BACKGROUND

Storage facilities may include, for example, self-storage units, warehouses, and mobile storage units. Storage facility operators may lease out space for use by customers. Customers may lease storage facilities to store, for example, residential, industrial, and/or commercial items. Service operators may, for example, provide transportation services to and from storage facilities.

### SUMMARY

Apparatus and associated methods relate to a dynamic contiguous fractional space allocation engine. In an illustrative example, the allocation engine may be configured to predetermine a plurality of unique units of fractional space for an operator defined physical storage space. The allocation engine may be configured to receive a space request for items having predetermined space requirements. Unique IDs may be generated for the items. The allocation engine may be configured to determine unused unique units of fractional contiguous space sufficient to receive the items. The items' unique IDs may be associated with the unique units of fractional contiguous space. The allocation engine may advantageously dynamically allocate contiguous storage space by fractionalizing a larger storage space, dynamically assign storage customers to storage operators, and/or automatically coordinate interactions between customers, operators, and/or transporters.

Various embodiments may achieve one or more advantages. For example, some embodiments may advantageously reduce expenses for storage space customers. Various embodiments may advantageously reduce time and/or increase convenience for storage space customers. Various embodiments may advantageously increase revenues for storage facility operators. Various embodiments may advantageously permit multiple tenants to simultaneously lease portions of one or more open storage spaces. Various embodiments may advantageously provide a technical solution to various problems associated with dynamically allocating storage space according to one or more predefined storage units.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary system that can dynamically allocate contiguous space to one or more users by fractionalizing a larger space.

FIG. 2 depicts a block diagram of the exemplary system with different exemplary tables stored in the system, and different exemplary actions can be performed by different parties.

FIG. 3A depicts a flow chart of an exemplary method to create an operator table.

FIG. 3B depicts an illustration of an exemplary unit to be implemented in the operator table.

FIG. 4A depicts a flow chart of an exemplary method of allocating space to a user.

FIG. 4B depicts an illustration of an exemplary unit to be updated in the operator table after space is allocated to a user.

FIG. 5 depicts a flow chart of an exemplary method of retrieving a package from the allocated space to the user.

FIG. 6 depicts a flow chart of an exemplary method of creating a driver table.

Like reference symbols in the various drawings indicate like elements.

### DETAILED DESCRIPTION OF ILLUSTRATIVE EMBODIMENTS

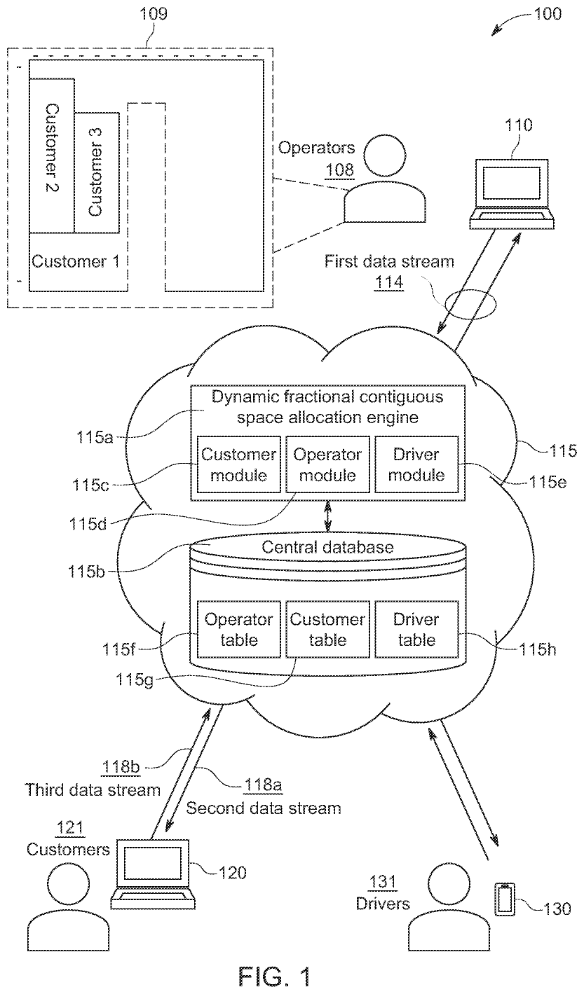

FIG. 1 depicts an exemplary system that can dynamically allocate contiguous space to one or more users by fractionalizing a larger space. In this depicted example, system 100 includes a first set of personal computing devices 110. One or more operators 108 who owns storage facilities 109 (e.g., storage spaces) may create a first data stream 114 to cloud 115, through the personal computing device 110, to include, for example, personal information (e.g., contact number, the location of the storage facilities), the configuration of the storage facilities 109 (e.g., the size and/or the shape of the storage facilities) and the price for each cell of each storage space/storage unit. The storage space/storage unit 109 may be divided into small contiguous cells such that operators 110 may lease their available storage space to one or more customers 121 (e.g., single storage space can host multiple tenants), and the customers 121 may lease only a fractional space from a storage unit operator 108. As the cost of the fractional space of a storage unit may be less than a whole storage unit, a customer 121 may advantageously reduce his expenses.

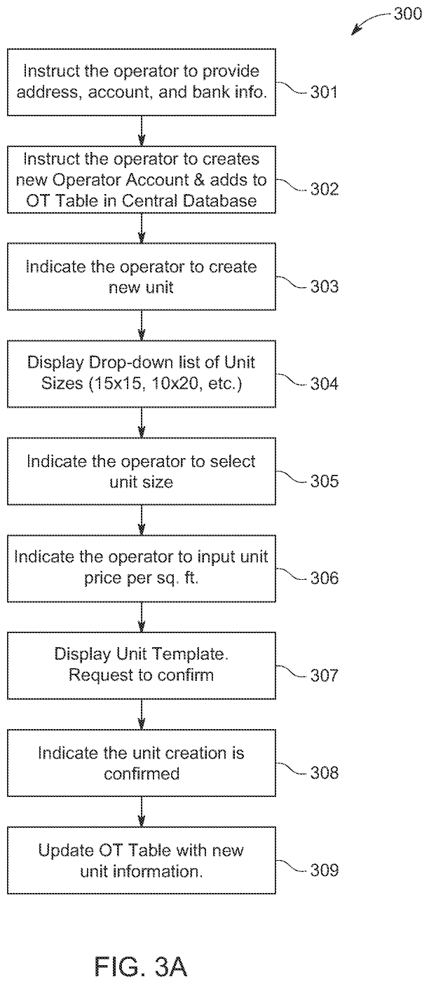

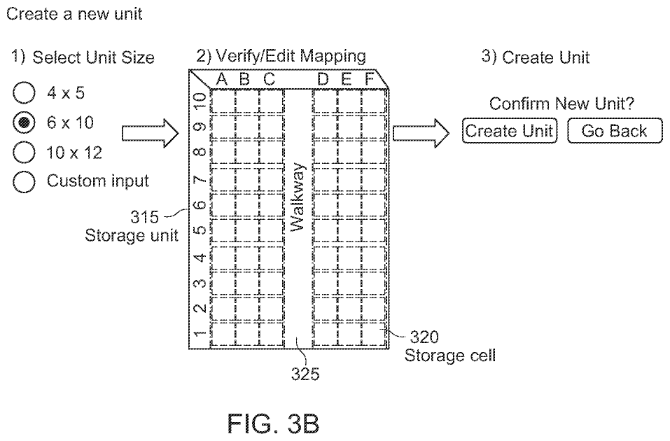

More specifically, the cloud 115 includes a dynamic fractional contiguous space allocation engine 115a coupled to a central database 115b. In some embodiments, the dynamic fractional contiguous space allocation engine 115a includes an operator module 115c, a customer module 115d, and a driver module 115e. These three modules may be applications that will be run on the cloud 115. The compute devices 110,120,130 may be the physical interfaces (PCs/mobile devices) where individuals can access the engine 115a via the intemet. The central database 115b may be configured to store a program of instructions that, when executed by the dynamic fractional contiguous space allocation engine 115a, cause the dynamic fractional contiguous space allocation engine 115a to perform operations to generate and/or update data in the database 115b and indicate corresponding information to related parties (e.g., operators, customers, and/or drivers). For example, the dynamic fractional contiguous space allocation engine 115a may receive the first data stream and process the first data stream to create an operator table 115f. The operator table 115f may be then stored in the central database 115b. An exemplary method to generate the operator table is discussed in further detail with reference to FIG. 3A.

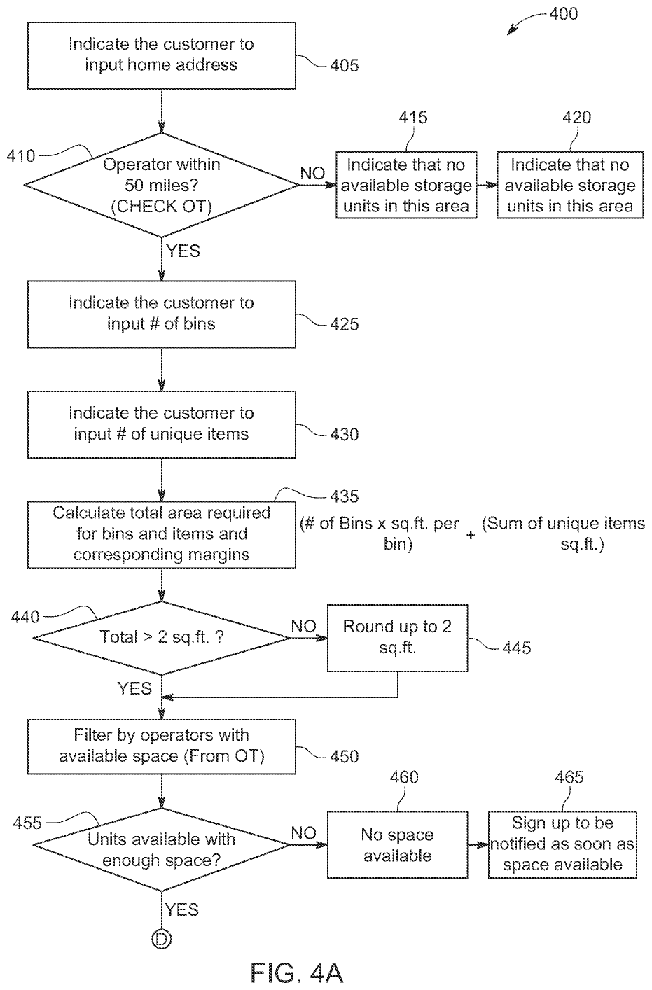

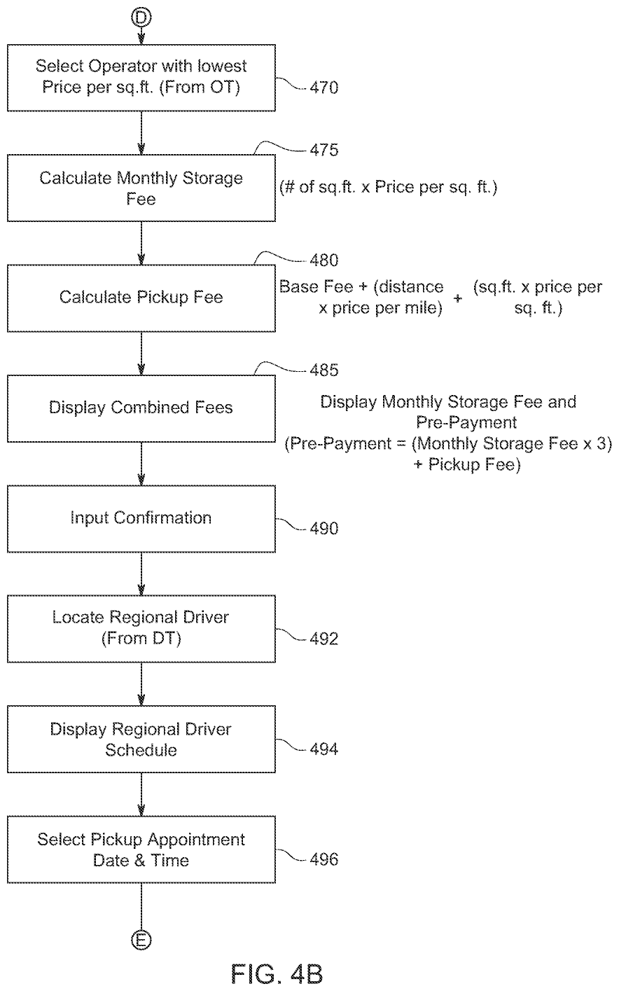

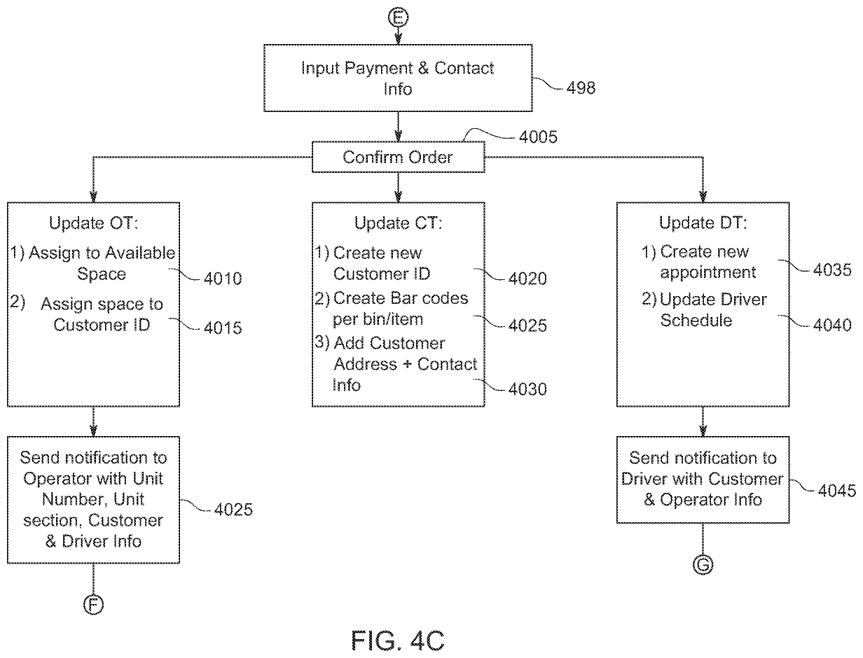

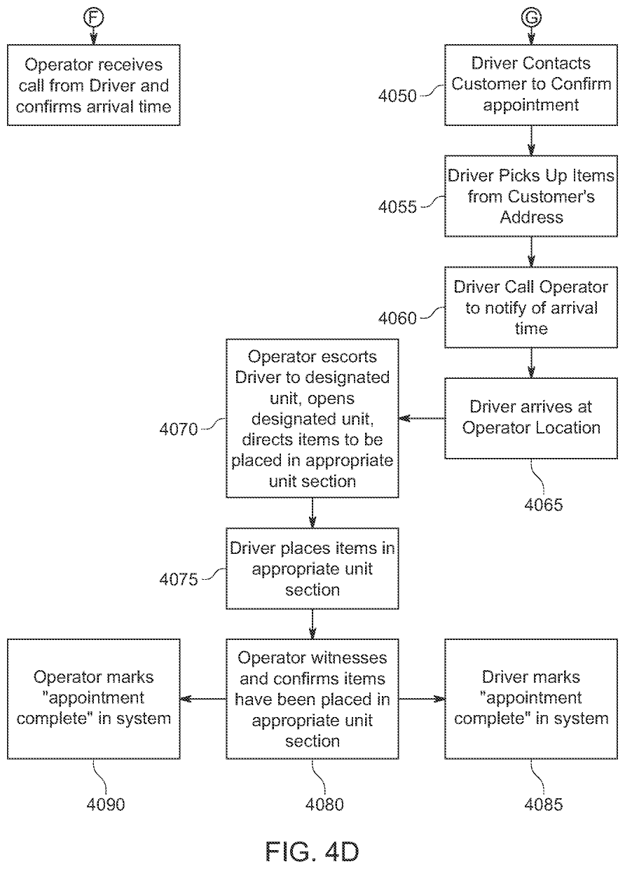

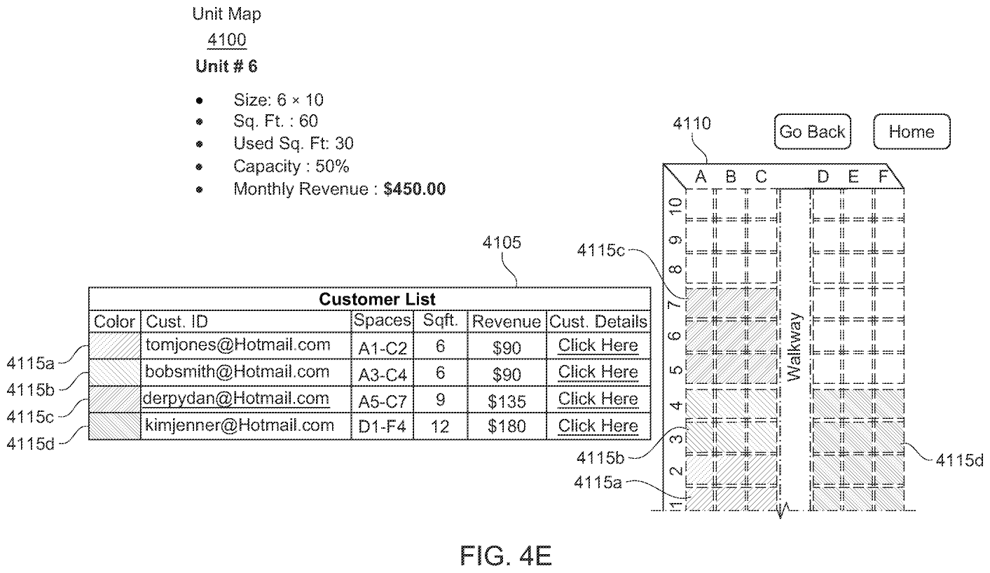

The system 100 includes a second set of personal computing devices 120. One or more customers may use the second set of personal computing devices 120 to search available storage spaces that meet their requirements (e.g., storage time, needed storage size, location of the storage unit). The one or more customers 121 may create a second data stream 118a through the second set of personal computing devices 120. When the dynamic fractional contiguous space allocation engine 115a receives the second data stream 118a, the dynamic fractional contiguous space allocation engine 115a may create a customer table 115g and store the customer table 115g in the central database 115b. The dynamic fractional contiguous space allocation engine 115a may be configured to pull out related storage cells' information from the operator table 115f and instruct the personal computing device 120 to show qualified results that meet the customer's 121 requirements through a third data stream 118b. When the customer 121 selects the storage cells, which means the selected storage cells are no longer available to others, the personal computing devices 120 may send a new data stream to the dynamic fractional contiguous space allocation engine 115a. The dynamic fractional contiguous space allocation engine 115a may then update the operator table 115f to show the latest availabilities of each cell of each storage space/storage unit 109. An exemplary method to allocate the storage cells of a storage unit is discussed in further detail with reference to FIG. 4A.

The system 100 includes one or more drivers 131. The drivers 131 may create their profile and upload their availabilities to the cloud 115 through a third of personal computing devices 130. The dynamic fractional contiguous space allocation engine 115a may then create a driver table 115h in the central database 115b. When the customer 121 selects the storage cells, the dynamic fractional contiguous space allocation engine 115a may pull out available drivers' information and further instruct the customer 121 to select an available driver 131. When the driver's time window is booked by the customer 121, the dynamic fractional contiguous space allocation engine 115a may then update the driver's availability and mark the appointment on the driver's calendar, for example.

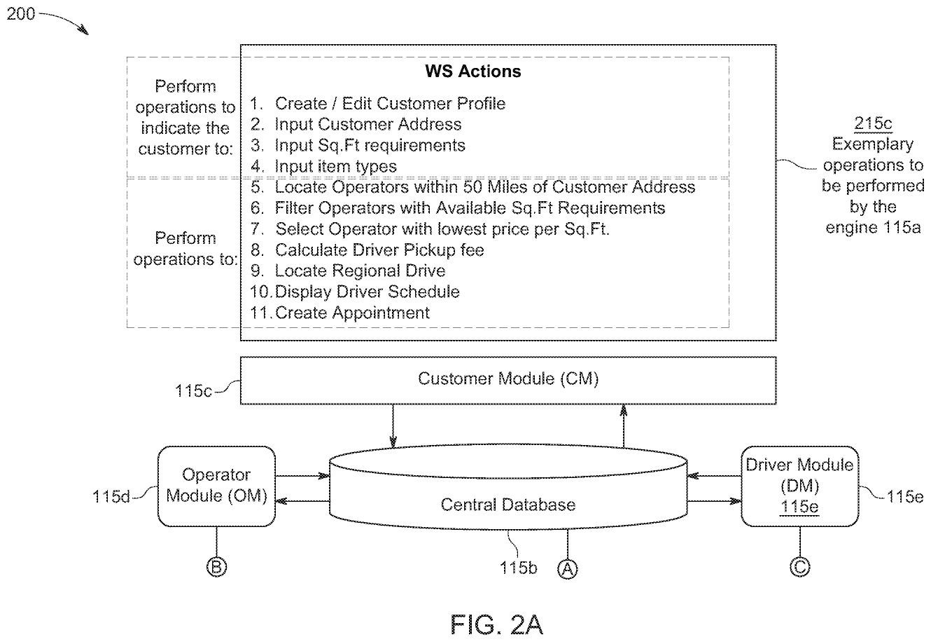

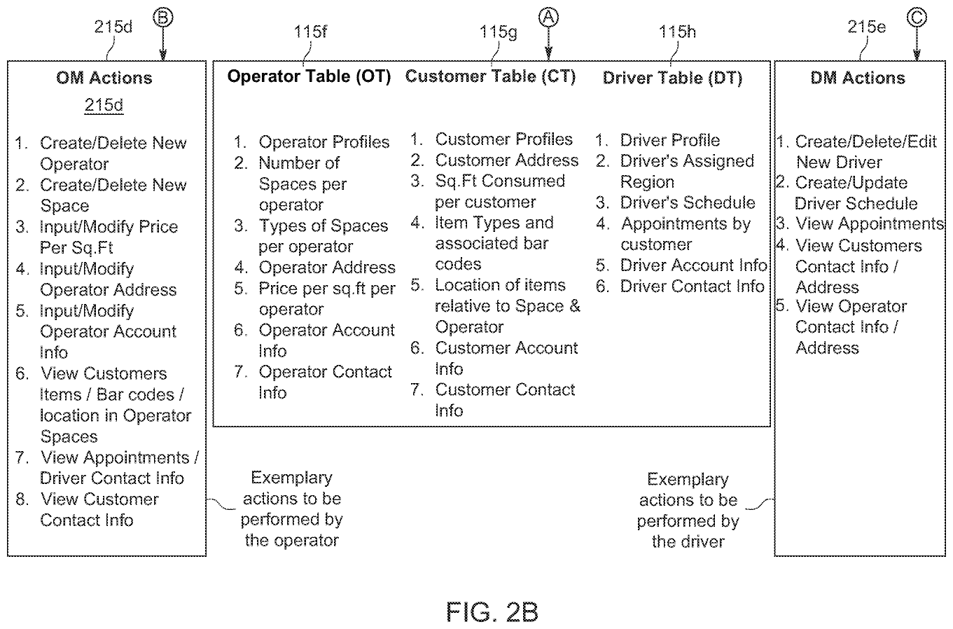

FIG. 2 depicts a block diagram of the exemplary system with different exemplary tables stored in the system, and different exemplary actions can be performed by different parties. As discussed with reference to FIG. 1, system 200 includes the central database 115b. Central database 115b includes the operator table OT 115f, the customer table CT 115g, and the driver table DT 115h. Corresponding exemplary contents that may be stored in a corresponding table are shown in FIG. 2.

Exemplary operations 215c that may be performed by the dynamic fractional contiguous space allocation engine 115a are also shown in FIG. 2, including operations performed to indicate to the customer 205a, and other operations performed 205b. By performing those functions, the tables in the central database 115b may be formed and dynamically updated. The customer may select one or more storage cells of a storage unit from a list of available storage units. In some embodiments, the customer may apply different filters to further select available storage units from the list of available storage units. In some embodiments, the customer may apply his preference (e.g., the price of each story cell in the storage unit, the location of the story unit) to view the list of available storage units. In some embodiments, the dynamic fractional contiguous space allocation engine 115a may be configured only to show the customer the cheapest available storage unit. Exemplary operations 215d that may be initiated by an operator and effected by operator module 115d are shown. Exemplary operations 215e that may be initiated by an operator and effected by operator module 115e are shown.

FIG. 3A depicts a flow chart of an exemplary method to create an operator table. An exemplary method 300 (e.g., exemplary operations to be performed by the dynamic fractional contiguous space allocation engine 115a) to create an operator table includes, at 301, instructing the operator to provide an address, account, and bank information. The method 300 also includes, at 302, instructing the operator to create a new operator account and adding the new operator account to the operator table. The method 300 also includes, at 303, indicating the operator to create a new storage unit. The method 300 also includes, at 304, displaying a drop-down list of unit sizes (e.g., 15′×15′). The method 300 also includes, at 305, indicating the operator to select a unit size. The method 300 also includes, at 306, indicating the operator to input unit price (e.g., unit price/sq. Ft). The method 300 also includes, at 307, displaying unit templates and indicating the operator to confirm the selected unit template. The method 300 also includes, at 308, indicating the unit is created and, at 309, updating the operation table with the newly created unit information. By creating the operator table (OT) with the confirmed storage unit template, the operator may lease their available storage space to one or more customers (e.g., a single storage space (e.g., the storage unit) can host multiple tenants), and the customers may lease only a fractional space of a storage unit from the operator. As the cost of the fractional space of a storage unit may be less than a whole storage unit, a customer may advantageously reduce his expenses. And the operator's revenue may be advantageously increased.

FIG. 3B depicts an illustration of an exemplary unit to be implemented in the operator table. An exemplary template of the storage unit 315 is shown. In this depicted example, the storage unit 315 is divided into multiple storage cells 320 and a walkway 325. A customer may, for example, choose to only lease one or more cells 320 in the unit 315 to meet his storage requirement.

FIG. 4A depicts a flow chart of an exemplary method of allocating space to a customer. An exemplary method 400 of allocating (e.g., by the engine 115a) one or more cells of a storage unit to the customer includes indicating 405 to the customer to input a home address. The method also includes checking 410 whether there are storage units within, for example, 50 miles. If there are no available storage units within 50 miles, then the engine 115a may perform instructions to indicate 415 to the customer that no storage units are available in this area, and further prompt 420 the customer to sign up for updates.

If there are available storage units within 50 miles, then, the method 400 includes requesting 425 the customer to input the number of bins he may need. A plurality of different sizes of bins available may, for example, be shown. The method 400 also includes requesting 430 the customer to input the number of unique items (e.g., bicycles). The engine 115a may then calculate 435 the total storage space required for the number of bins and unique items. In some embodiments, a predetermined value for margin (e.g., 12% of the total storage space) may be applied to a corresponding type of bin and/or a corresponding type of unique item.

The method also includes checking 440 whether the final total space (the total space with the margins added) is greater than a predetermined minimum area (e.g., 2 sq. Ft). If the final total space is less than the minimum area, then, the final total space is rounded up 445 to the minimum area. When the final total space is no less than the minimum area, then, the engine 115a may be configured to filter 450 available spaces/ units from the operation table in the central database 115b.

The method also includes determining 455 whether those available units have enough space. If the available units in the area do not have enough space, the engine 115a may notify 460 the customer that there's no available space and help 465 the customer to sign up to be notified as soon as space is available. If there are available units with available spaces, then the engine selects 470 the operator with the lowest price and calculate 475 a corresponding monthly storage fee based on the final total space. The engine 115a may also calculate 480 the pickup fee for the corresponding bins and unique items and display 485 the combined fees. When the customer confirms 490 the fees and related service, the engine 115a may then locate 492 regional drivers (e.g., from the driver table) and display 494 regional drivers' schedules. The engine 115a may then instruct the customer to select 496 a driver and pickup time. After the engine 115a receives corresponding inputs 498 from the customer, the engine 115a may instruct the customer to confirm the order.

After the order is received 4005 by the engine 115a, the engine 115a may update the operator table, the customer table, and the driver table. More specifically, for the operator table, the engine 115a may assign 4010 this order to available spaces (e.g., available cells) of the available unit, and also assign 4015 the available related spaces to the customer ID. Then, the engine 115a may send 4025 a notification to the operator with the unit number, unit sections (e.g., unit cells), and customer and driver information. The engine 115a may also update the customer table. For example, the engine 115a may create 4020 a new customer ID for this customer, create 4025 bar codes for the bins and/or unique items, and add 4030 the customer address and contact information into the customer table. The engine 115a may also update the driver table. For example, the engine 115a may create 4035 a new appointment for the driver regarding the pickup time and then update 4040 the driver's schedule. Then engine 115a may then send 4045 a notification to the driver with customer information and operator information.

In some embodiments, the driver may then contact 4050 the customer to confirm the appointment, pick up 4055 the items from the customer, contact 4060 the operator to notify the expected arrival time. When the driver arrives 4065 at the storage location, the operator may escort 4070 the driver to designed units, and direct items to be placed in appropriate one or more cells (e.g., unit sections). When the driver places 4075 items in the assigned place, the operator may confirm 4080 that the items have been placed in the designated section. Both the driver 4085 and the operator 4090 may then mark “appointment completed” in the system 100.

FIG. 4B depicts an illustration of an exemplary unit 4100 to be updated in the operator table 4105 after space is allocated to a customer (e.g., customers 4115a-4115d). As shown in FIG. 4B, the storage unit 4110 is regarded as multiple cells (depicted as an array of cells denoted by vertical indicia 1-10 and horizontal indicia A-F). by way of example and not limitation, a first group of cells (A5 through C7) may be leased by a first customer 4115a, a second group of cells (A3 through C4) may be leased by a second customer 4115b, a third group of cells (A1 through C2) may be leased by a third customer 4115c, and a fourth group of cells (D1 through F4) may be leased by a fourth customer 4115d. A customer may lease only a fractional space of a storage unit from the operator. As the cost of the fractional space of a storage unit may be less than a whole storage unit, a customer may advantageously reduce his expenses.

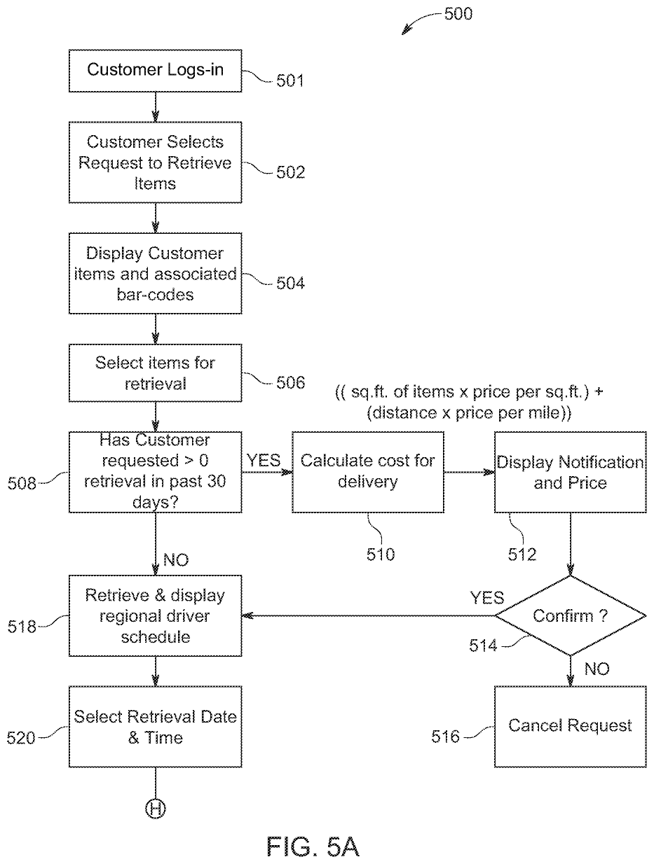

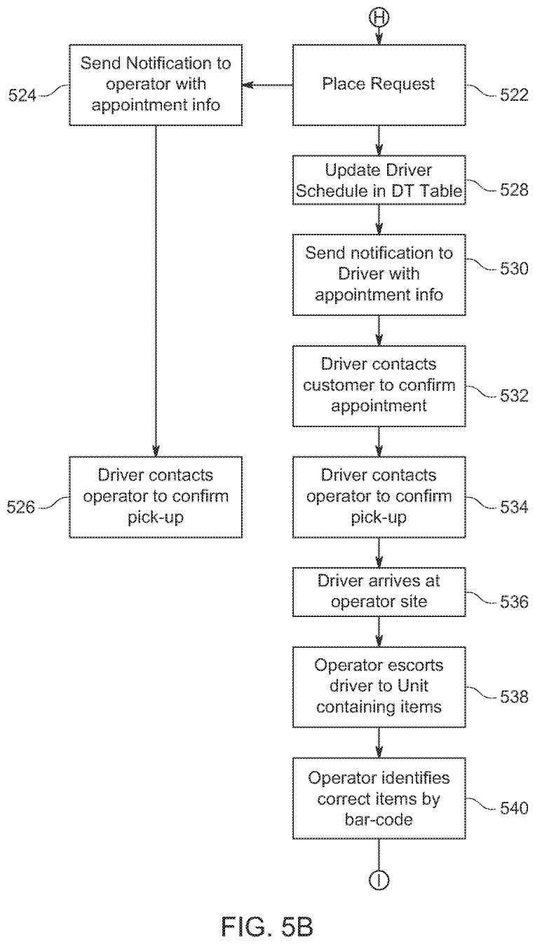

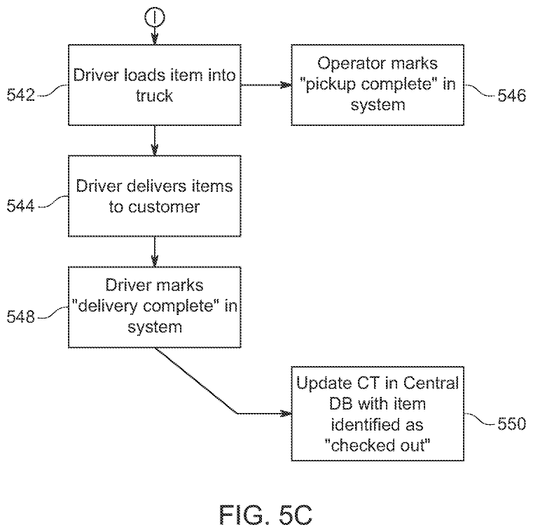

FIG. 5 depicts a flow chart of an exemplary method of retrieving a package from the allocated space to the user. In some situations, the customer may want to retrieve some part of the whole of the stored items. The system 100 may enable the retrieving process convenient and assured. A method 500 of retrieving items includes receiving 502 (e.g., by the engine 115a and the customer module) customer's request to retrieve items. The method also includes displaying 504 items related to the customer and associated bar-codes. When the engine 115a or the customer module receives 506 the customer's instruction regarding selected items for retrieval, the engine 115a determines 508 whether the customer has requested no less than one item retrieval in, for example, the past 30 days (e.g., whether the customer has used his monthly free delivery). If the customer has requested any item retrieval in the past 30 days, then the engine 115a calculates 510 the cost for delivery and displays 512 an exemplary notification and the related price regarding the retrieving delivery. Exemplary cost calculation and notification are shown in FIG. 5. When the engine 115a doesn't receive the customer's confirmation 514 regarding the delivery fee, the engine 115a then cancels 516 the retrieving request. When the engine 115a receives the customer's confirmation regarding the delivery fee, the engine 115a retrieves 518 the driver table and displays the regional driver schedule. If the customer has requested any item retrieval in the past 30 days, then the engine 115a also retrieves 518 the driver table and displays the regional driver schedule.

The method also includes requesting the customer to select 520 retrieval data and time. After the customer has made the selection and placed the request 522, the engine 115a then sends 524 a notification to the corresponding operator with the appointment information. The operator may receive 526 a call from the driver to confirm an arrival time (e.g., as a result of step 534). The method also includes updating 528 the driver schedule in the driver table and sending 530 a notification to the selected driver with the appointment information.

In some embodiments, after receiving the appointment information, the driver may contact 532 the customer to the appointment, contact 534 the operator to notify the expected arrival time. When the driver arrives 536 at the storage location, the operator may escort 538 the driver to the designed units. The operator may then identify 540 the corrected items by the bar-code. The driver may then load 542 the retrieved items into one or more trucks and deliver 544 the items to the customer. After both the operator 546 and the driver 548 mark the “complete” in the system, the customer table may then be updated 550 in the central database (with the retrieved item identified as “checked out,” for example).

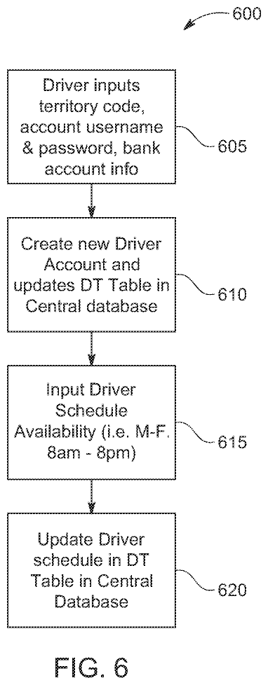

FIG. 6 depicts a flow chart of an exemplary method to create a driver table. An exemplary method 600 (e.g., exemplary operations to be performed by the dynamic fractional contiguous space allocation engine 115a) to create a driver table includes instructing the driver to provide and/or receiving 605 from the driver an address information (e.g., territory code assigned to the region), account, and bank information. The method also includes instructing the driver to create a new driver account and/or generating 610 a new driver account according to the driver input and adding the new driver account to the driver table. The method also includes indicating the driver to input schedule availability (e.g., Monday-Friday, 8 AM-8 PM) and/or receiving 615 input from the driver indicating the driver's schedule. The method also includes updating 620 the driver Schedule in the driver table in the central database 115b. As the driver's availability is included in the system 100, the customer may select among those available schedules and no need to contact other drivers such that the customer may advantageously save his time on the storage arrangement.

Although various embodiments have been described with reference to the figures, other embodiments are possible. For example, the system 100 may be used to allocate continuous storage cabinets with lockers to a customer (e.g., a customer has 2 items, the system 100 may allocate a 1^{st} locker to store the 1^{st} item and allocate a continuous 2^{nd} locker to store the 2^{nd} item). For example, if a post office may use the system and be able to auto assign the closest available P.O box to a customer based on a given location (e.g., Bob wants a P.O. box close to his apartment in Dallas also wants a P.O box close to where he works, he could request two separate boxed based on inputs on the system 100, with minor tweaking, the system 100 may be used to find and assign his P.O boxes). In some embodiments, the system 100 may be used for dynamically assigning and tracking of rental equipment(s). For example, property developers may subdivide large acres of land into smaller lots then track their sale by using this system 100. In some embodiments, the system 100 may also be used for warehousing management, intra-state shipping, international shipping (e.g., c-cans), for example.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Although an example of a system, which may be portable, has been described with reference to the above figures, other implementations may be deployed in other processing applications, such as desktop and networked environments.

Although particular features of an architecture have been described, other features may be incorporated to improve performance. For example, various embodiments may predetermine a plurality of unique units of fractional space for an operator defined physical storage space, receive a space request for items having predetermined space requirements, generate unique IDs for the items, determine unused unique units of fractional contiguous space sufficient to receive the items, and associate the items' unique IDs with the unique units of fractional contiguous space. Various embodiments may perform one or more functions. The functions may include, by way of example and not limitation, dynamically allocating contiguous storage space by fractionalizing (e.g., subdividing) a larger storage space. The functions may include, by way of example and not limitation, dynamically assigning storage customers (e.g., lessees) to storage operators (e.g., landlords). The functions may include, by way of example and not limitation, automatically coordinating: (1) tracking and monitoring of items stored by customers, (2) pickup and delivery of items from and/or to customers, and/or (3) organization and storage of items.

Dynamic allocation of contiguous space by fractionalizing a larger space may, for example, include storage site owners adding storage units to a database via a pre-defined template, including, for example, a desired price per predefined storage unit (e.g., square foot). A dynamic engine (e.g., 115a) may then create an alpha-numeric grid of the space in order to fractionalize the unit into individual predefined storage units (PSUs). In various embodiments, a PSU may, by way of example and not limitation, be defined as a square foot.

Once the unit is fractionalized into multiple PSUs, dynamically assigning storage customers (e.g., lessees) to storage operators (e.g., landlords) may include, for example, a dynamic engine (e.g., 115a) interacting with customers to lease a minimum number (e.g., at least two or more) of these PSUs from a storage operator within a specific geographic region. Therefore, a single storage space may advantageously host multiple tenants. The storage space may be determined by the items (e.g., quantity, type, size) the user requests to store. Contiguous alpha-numeric fractionalized units may be selected and assigned to the user for the requested items. The number of units may be determined, for example, based on item quantity, type, and size. The number of units may be further determined by calculating space required using a ‘fudge factor’ (e.g., margin value) to take into account, for example, imperfections in stacking and walkways required.

When a customer leases a fractional space from a storage unit operator, automatic coordination may include, for example, creating a unique customer ID for the customer. Contiguous alpha-numeric fractionalized units may be assigned to the customer ID based, for example, on the number of units the customer requires. Unique itemized bar-codes may be assigned, for example, for each of the customer's bins or large items. The itemized bar-codes may be recorded in the database in association with the bin/item type, the customer ID, and/or alpha-numeric IDs of the selected fractionalized units where the items will be stored.

In various embodiments, a customer may select a time for a driver to pickup their items for delivery to a leased PSUs based, for example, on a real-time schedule of a driver for the local region. Once the time is selected, the driver's schedule may be updated dynamically and the driver may be notified of the new pick-up appointment. A notification may be sent to the self-storage operator with the driver's estimated arrival time and contact information, together, for example, with the customer's information, location of where the items are supposed to be stored, and the individual item bar codes and types.

In various embodiments, pictures of items to be stored (e.g., the item itself, or a picture of each bin's contents) may be associated with the item barcodes. A customer's stored inventory, with pictures, may be retrievable by the customer. The customer may request some or all of the stored inventory. A request may be subsequently generated including the item barcodes requested, the storage location, and the unique fractionalized units where the items are stored. Item records may also record, for example, whether or not individual items are checked-in or checked-out.

Various embodiments may, by way of example and not limitation, provide a technical solution to the problem of dynamically allocating contiguous fractional space of one or more landlords to be leased by, for example, one or more customers. Accordingly various embodiments may, for example, advantageously provide dynamic allocation of a predetermined storage space across a plurality of customers according to one or more PSUs. Various embodiments may, for example, advantageously enable a customer to advantageously find storage optimally matched to their items for storage. Various embodiments may, for example, advantageously assign one or more lessees to one or more storage operators according to one or more predetermined rules. Various embodiments may, for example, advantageously enable landlords to maximize rental by, for example, connecting them to customers wanting optimal storage space.

Various embodiments may, for example, provide a technical solution to the problem of securely leasing out portions of open storage spaces by, for example, advantageously coordinating between customers, operators, and/or drivers to provide for secure access to larger storage spaces having multiple customers assigned thereto. Various embodiments may, for example, provide a technical solution to the problem of leasing portions of open storage spaces by, for example, coordinating tracking, monitoring, organization, storage, delivery, and/or pickup of items stored by customers.

In various embodiments, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital and/or analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions by, for example, operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented, for example, in a computer system that includes a graphical user interface and/or an Internet browser. To provide for interaction with a user, some implementations may be implemented on a computer having a display device, such as a CRT (cathode ray tube) or LCD (liquid crystal display) monitor for displaying information to the user, a keyboard, and a pointing device, such as a mouse or a trackball by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, and the computers and networks forming the Internet. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, or multiplexing techniques based on frequency, time, or code division. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits and/or other modules. In various examples, the modules may include analog and/or digital logic, discrete components, traces and/or memory circuits fabricated on a silicon substrate including various integrated circuits (e.g., FPGAs, ASICs). In some embodiments, the module(s) may involve execution of preprogrammed instructions and/or software executed by a processor. For example, various modules may involve both hardware and software.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

What is claimed is:

1. A computer program product comprising a program of instructions tangibly embodied on a computer readable medium, wherein when the instructions are executed on a processor, the processor causes operations to be performed to dynamically allocate contiguous fractional space, the operations comprising:
predetermine a plurality of unique units of fractional space for an operator defined physical storage space;
receive a space request for at least one item having a predetermined space requirement;
generate at least one unique identification for the at least one item;
determine at least one unused unique unit of fractional contiguous space sufficient to receive the at least one item; and,
associate the at least one unique identification with the unique unit of fractional contiguous space.
